(19) United States
(12) Patent Application Publication
(10) Pub. No.: US 2019/0012641 A1
(43) Pub. Date: Jan. 10, 2019

(54) FREIGHT CAPACITY MAXIMIZATION SYSTEM

(71) Applicant: David Klyce Roberts, Dyersburg, TN (US)

(72) Inventor: David Klyce Roberts, Dyersburg, TN (US)

(21) Appl. No.: 15/750,401

(22) PCT Filed: Oct. 4, 2016
(86) PCT No.: PCT/IB16/55911

§ 371 Date: Feb. 5, 2018

Related U.S. Application Data
(60) Provisional application No. 62/200,884, filed on Aug. 4, 2015.

(51) Int. Cl. G06Q 10/08; G06Q 50/30; G06Q 10/06

(52) U.S. Cl. CPC G06Q 10/08355; G06Q 10/0631; G06Q 50/30; G06Q 10/087

(57) ABSTRACT

A system 100 for maximizing freight capacity utilization includes a user interface 102 for receiving shipment data and a database 104 for storing the received shipment data. The user interface 102 receives carrier data, and a means for matching 106 determines shipment data matching the received carrier data. A notifier 108 of the system 100 provides notice of the matched shipment data to the carrier 114. The carrier 114 can bid on a matched shipment corresponding to the matched shipment data, and the notifier 108 notifies the shipper 112 of the bid. If the shipper 112 accepts the bid, the system 100 notifies the carrier 114 of the accepted bid and provides additional information about the shipper 112 such that the shipment can be completed by the carrier 114.

### TECHNICAL FIELD

The present invention relates generally to allocating shipments to transports. More particularly, this invention pertains to connecting carriers with unused capacity to shippers with suitable shipments.

### BACKGROUND ART

The freight transportation industry is very inefficient. The semi-trucks that are used to transport goods are usually not filled to capacity (weight and/or volume) and are often completely empty while moving from a drop off location to a pickup location which is often a great distance from the drop off location. The industry currently focuses on getting a shipment from one place to another on a transport, regardless of an excess capacity of the transport, instead of filling a transport filled with shipments each time the transport moves from one place to another. Filling the transport (e.g., semi-truck, box truck, pickup, trailer, boat, cargo plane, etc.) to capacity is the most energy efficient, cost effective, and profitable way to move shipments.

### DISCLOSURE OF THE INVENTION

Aspects of the present invention provide a system and method for allocating shipments to spare capacity on transports.

In one aspect, a system for maximizing freight capacity utilization includes a user interface, a database, a means for matching, and a notifier. The user interface is configured to receive shipment data from a shipper and carrier data from a carrier. The database is configured to store the received shipment data. The means for matching is configured to match shipment data stored in the database to the received carrier data. The user interface is further configured to display matched shipment data to the carrier and received from the carrier a bid on a shipment corresponding to the matched shipment data. The notifier is configured to notify the shipper of the dead in response to receiving the bid on the shipment from the carrier. The shipper corresponds to the shipment data in the bid received from the carrier. The user interface is further configured to receive input from the shipper accepting the bid. The notifier is further configured to notify the carrier of the accepted bid and response to receiving, via the user interface, the input from the shipper accepting the bid.

In another aspect, a method of maximizing freight capacity utilization includes receiving, via a user interface, shipment data from a shipper and carrier data from a carrier. The received shipment data stored in a database. A means for matching matches shipment data stored in the database to the received carrier data. The user interface displays matched shipment data to the carrier. The user interface receives from the carrier, a bid on a shipment corresponding to the matched shipment data. A notifier notifies the shipper of the bid in response to receiving the bid on the shipment from the carrier. The shipper corresponds to the shipment data in the bid received from the carrier. Input is received from the shipper accepting the bid via the user interface. The notifier notifies the carrier of the accepted bid in response to receiving the input from the shipper accepting the bid via the user interface.

### BRIEF DESCRIPTION OF THE DRAWINGS

FIG. 1 is a schematic diagram of a system for maximizing freight capacity utilization.

Reference will now be made in detail to optional embodiments of the invention, examples of which are illustrated in accompanying drawings. Whenever possible, the same reference numbers are used in the drawing and in the description referring to the same or like parts.

### BEST MODE FOR CARRYING OUT THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

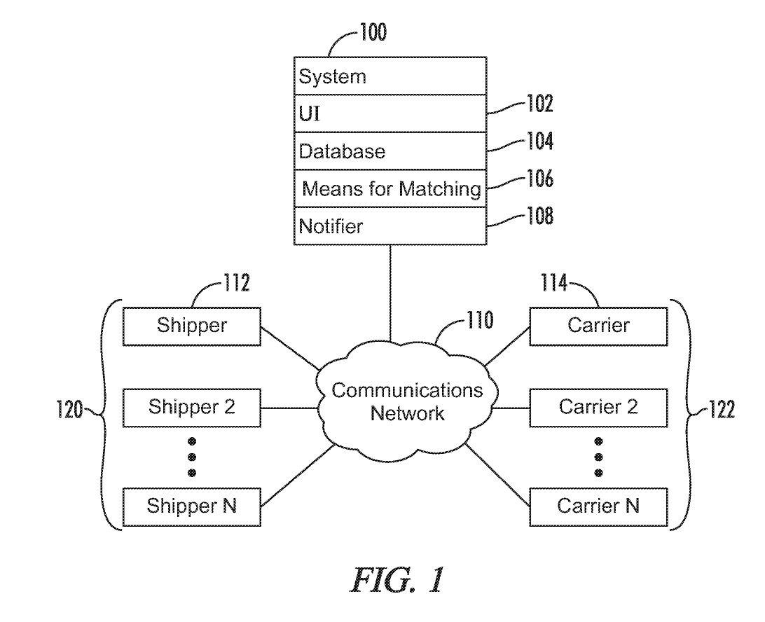

Referring to FIG. 1, a system 100 for maximizing freight capacity utilization includes a user interface 102, a database 104, a means for matching 106, and a notifier 108. The system 100 is a communications network 110 enabled platform that matches unused cargo space to entered cargo. The system 100 matches the cargo size, weight, destination, origination, time, and transport type requirements to available shipping capacity that matches those requirements. Payment for the shipment is also brokered by the system 100.

In one embodiment, the process provided by the system 100 begins with users creating accounts in the system 100 by entering account information via the user interface 102. Account information includes name, address, company name, and contact number. The account information may also include an election of shipper, carrier, or both. Users who need cargo (i.e., freight) moved are classified as a shipper 112 in the system 100. Users who operate transports (e.g., semi-trucks, boats, box trucks, trailers, etc.) to move cargo are classified as a carrier 114 in the system 100.

The user interface 102 is configured to receive shipment data from shipper 112 and carrier data from a carrier 114 via the communications network 110. In one embodiment, carrier data includes a weight capacity available, a volume available, a transport type, a transport route, and a travel date. In one embodiment, the transport route includes a directed graph of global positioning system coordinates, and in another embodiment, the transport route includes an origin identifier and a destination identifier. In one embodiment, the travel date is a range of time or days. In one embodiment, transport type options include enclosed, open-air, refrigeration, and specialty. In one embodiment, shipment data includes a weight, size, transport type, an origination identifier, a destination identifier, a data available, and a delivery date. In one embodiment, a shipment may include a plurality of pieces, each having a weight and a size, and the shipment data for the shipment may include a quantity of pieces in addition to the weight and the size of each piece. In one embodiment, the size is a length and a width; and in another embodiment, the size is a length, a width, and a height. The available date is the earliest date which the shipment is ready for pickup. The delivery date is the latest acceptable date for delivery. The user interface 102 may further be configured to receive as part of the shipment data information such as a picture, federal cargo classification number, and any notes for the shipment. In one embodiment, the user interface 102 is configured to receive carrier data for each transport of a plurality of transports from a carrier of a plurality of carriers 122.

When a user logs into their account (e.g., provides their username and password to the system 100), users designated as a shipper 112 are shown a user interface 102 where they can enter shipment data defining shipments to be bid on, track shipments that are en route, and delete cargo from a shipment with a bid (i.e., change the shipment data associated with the shipment). Similarly, when a user designated as a carrier 114 logs into their account, they are shown a user interface where they can enter available space on a transport (i.e., carrier data) including the location and times it is available. Carriers can also indicate that a shipment is complete via the user interface 102. It is contemplated within the scope of the claims that entering carrier data and shipment data via the user interface 102 may occur via manual entry in a web page or web form format, or via bulk upload in a designed file format (e.g., comma separated values files of a defined structure). Additionally, logging in to an account may occur by manual entry of account information (e.g., username and password) or by automatic provision of a key or token by a computing device in use by the user when an application on the computing device is accessed or upload/retrieval of data is requested by the user via an application on the computing device.

The database 104 is configured to store the received shipment data. In one embodiment, the user interface 102 is configured to receive shipment data for each shipment of a plurality of shipments from a shipper 112 play plurality of shippers 120. The database 104 is configured to store the shipment data for each shipment of the plurality of shipments. The database 104 may include the account information, or the account information may be stored in a separate database of the system 100.

The means for matching 106 is configured to match shipment data stored in the database 104 to the receive carrier data. The user interface 102 is further configured to display matched shipment data to the carrier 114 and receive from the carrier 114 a bid on a shipment corresponding to the matched shipment data.

In one embodiment, the means for matching 106 executes and algorithm to match the shipment data stored in the database 104 to the received carrier data by filtering the database 104 stored shipment data to generate a filtered list of shipments. Filtering the database 104 includes excluding shipment data associated with the shipments having a weight greater than a weight capacity available of the received carrier data, and excluding shipment data associated with shipments having a size greater than the volume available of the received carrier data. Filtering further includes excluding shipment data associated with shipments having a delivery date before a travel date of the received carrier data or an available date after the travel date of the received carrier data. In one embodiment, the travel date may be a collection of dates defining a range of time. In one embodiment, shipment data associated with shipments having a transport type incompatible with the transport type of the received carrier data is also excluded as part of the filtering by the means for matching 106. That is, for example, if the shipment requires enclosed transport in the carrier type is an open-air transport, then the shipment is excluded from the filtered list of shipments. In one embodiment, the matching algorithm executed by the means for matching 106 continues with determining a total distance for each shipment in the filtered list of shipments.

In one embodiment, determining the total distance includes determining a first distance between an origin identifier of the shipment date of the shipment and an origin identifier of the received carrier data. A second distance between the destination identifier of the shipment data of the shipment and the destination identifier of the received carrier data is also determined. The total distance for the shipment is determined by adding the first distance with the second distance. The algorithm executed by the means for matching 106 concludes with ordering the filtered list as a function of the determined total distance for each shipment in the filtered list of shipments.

In another embodiment, determining the total distance includes determining a first distance between the origin identifier of the shipment data of the shipment and the transport route of the received carrier data. The means for matching 106 also determines a second distance between a destination identifier of the shipment date of the shipment and the transport route of the received carrier data. The total distance for the shipment is determined by adding the first distance to the second distance. In one embodiment, shipments having a destination identifier closer to a beginning of the transport route than an origin identifier of the shipment are excluded from the filtered list. The algorithm executed by the means for matching 106 concludes with ordering the filtered list as a function of the determined total distance for each shipment in the filtered list of shipments.

The notifier 108 is configured to notify the shipper 112 via the communications network 110 of the bid in response to receiving the bid on the shipment from the carrier 114. In one embodiment, the notifier 108 notifies the shipper 112 via email. In another embodiment, the notifier 108 notifies the shipper 112 via an operating system notification (e.g., Android notification). The user interface 102 is configured to receive input from the shipper 112 accepting the bid. The notifier 108 is further configured to notify the carrier 114 of the accepted bid in response to receiving the input from the shipper 112 accepting the bid. In one embodiment, the input received from the shipper 112 by the user interface 102 via the communications network 110 accepting the bid includes payment information, and the database 104 is further configured to store account information corresponding to the shipper 112. Notifying the carrier 114 of the accepted bid includes providing the stored account information corresponding to the shipper 112 from the database 104 to the carrier 114 via the user interface.

In one embodiment, the user interface 102 is further configured to receive input from the carrier 114 indicating that the shipment is complete. In response to receiving, via the user interface, the input from the carrier 114 indicating that the shipment is complete, the notifier 108 is further configured to request a rating of the carrier and 14 from the shipper 112 and a rating of the shipper 112 from the carrier 114. The rating may be on a predetermined scale or maybe a text based note (or combination thereof). The system 100 may further be configured to release payment information to a separate accounting system or to credit an account of the carrier 114 with payment from the shipper 112.

In one embodiment, the system 100 is implemented via a computing device such as a server. The server may be a single physical device or distributed across multiple physical and virtual machines. The user interface 102 may be generated by the system 100 entirely and transmitted to computing devices used by carriers and shippers, or the computing devices (e.g., wireless telephones and computers) may contain a framework of the user interface for receiving data from the system 100 and displaying the view to the user.

It will be understood by those of skill in the art that navigating between user interface views is accomplished by selecting a tab or object in a current user interface view corresponding to another user interface view, and in response to selecting the tab or object, the user interface updates with said another user interface view corresponding to the selected tab or object.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful FREIGHT CAPACITY MAXIMIZATION SYSTEM it is not intended that such references be construed as limitations upon the scope of this invention except as set forth in the following claims.

What is claimed is:

1. A system for maximizing freight capacity utilization, said system comprising:
a user interface configured to receive shipment data from a shipper and carrier data from a carrier;
a database configured to store the received shipment data;
a means for matching, said means for matching configured to match shipment data stored in the database to the received carrier data, wherein the user interface is further configured to display matched shipment data to the carrier and receive from the carrier a bid on a shipment corresponding to the matched shipment data; and
a notifier configured to notify the shipper of the bid in response to receiving the bid on the shipment from the carrier, wherein:
the shipper corresponds to the shipment data in the bid received from the carrier;
the user interface is further configured to receive input from the shipper accepting the bid; and
the notifier is further configured to notify the carrier of the accepted bid in response to receiving, via the user interface, the input from the shipper accepting the bid.

2. The system of claim 1, wherein:
the user interface is further configured to receive shipment data for each shipment of a plurality of shipments from a shipper of a plurality of shippers;
the database is configured to store the shipment data for each shipment of the plurality of shipments; and
the means for matching matches the shipment data stored in the database to the received carrier data by:
filtering the database of stored shipment data to generate a filtered list of shipments, said filtering comprising:
excluding shipment data associated with shipments having a weight greater than a weight capacity available of the received carrier data;
excluding shipment data associated with shipments having a size greater than the volume available of the received carrier data;
excluding shipment data associated with shipments having a delivery date before a travel date of the received carrier data or an available date after the travel date of the received carrier data; and
excluding shipment data associated with shipments having a transport type incompatible with a transport type of the received carrier data;
determining a total distance for each shipment in the filtered list of shipments, wherein determining the total distance for a shipment comprises:
determining a first distance between an origin identifier of the shipment data of the shipment and an origin identifier of the received carrier data;
determining a second distance between a destination identifier of the shipment data of the shipment and the destination identifier of the received carrier data; and
adding the first distance with the second distance to determine the total distance for the shipment; and
ordering the filtered list as a function of the determined total distance for each shipment in the filtered list of shipments.

3. The system of claim 1, wherein:
the user interface is further configured to receive shipment data for each shipment of a plurality of shipments from a shipper of a plurality of shippers;
the database is configured to store the shipment data for each shipment of the plurality of shipments;
wherein the received carrier data comprises a transport route; and
the means for matching matches the shipment data stored in the database to the received carrier data by:
filtering the database of stored shipment data to generate a filtered list of shipments, said filtering comprising:
excluding shipment data associated with shipments having a weight greater than a weight capacity available of the received carrier data;
excluding shipment data associated with shipments having a size greater than the volume available of the received carrier data;
excluding shipment data associated with shipments having a delivery date before a travel date of the received carrier data or an available date after the travel date of the received carrier data; and
excluding shipment data associated with shipments having a transport type incompatible with a transport type of the received carrier data;
determining a total distance for each shipment in the filtered list of shipments, wherein determining the total distance for a shipment comprises:
determining a first distance between an origin identifier of the shipment data of the shipment and the transport route of the received carrier data;
determining a second distance between a destination identifier of the shipment data of the shipment and transport route of the received carrier data; and
adding the first distance with the second distance to determine the total distance for the shipment; and
ordering the filtered list as a function of the determined total distance for each shipment in the filtered list of shipments.

4. The system of claim 1, wherein:
the user interface is further configured to receive shipment data for each shipment of a plurality of shipments from a shipper of a plurality of shippers;
the database is configured to store the shipment data for each shipment of the plurality of shipments;
wherein the received carrier data comprises a transport route; and
the means for matching matches the shipment data stored in the database to the received carrier data by:
filtering the database of stored shipment data to generate a filtered list of shipments, said filtering comprising:
excluding shipment data associated with shipments having a weight greater than a weight capacity available of the received carrier data;
excluding shipment data associated with shipments having a size greater than the volume available of the received carrier data;
excluding shipment data associated with shipments having a delivery date before a travel date of the received carrier data or an available date after the travel date of the received carrier data; and
excluding shipment data associated with shipments having a transport type incompatible with a transport type of the received carrier data;
determining a total distance for each shipment in the filtered list of shipments, wherein determining the total distance for a shipment comprises:
determining a first distance between an origin identifier of the shipment data of the shipment and the transport route of the received carrier data;
determining a second distance between a destination identifier of the shipment data of the shipment and transport route of the received carrier data; and
adding the first distance with the second distance to determine the total distance for the shipment;
excluding, from the filtered list, shipments having a destination identifier closer to a beginning of the transport route than an origin identifier of the shipment; and
ordering the filtered list as a function of the determined total distance for each shipment in the filtered list of shipments.

5. The system of claim 1, wherein:
the database is further configure to store account information corresponding to the shipper; and
the input received from the shipper by the user interface accepting the bid is payment information; and
notifying the carrier of the accepted bid comprises providing stored account information corresponding to the shipper from the database to the carrier via the user interface.

6. The system of claim 1, wherein:
the user interface is further configured to receive input from the carrier indicating the shipment is complete; and
in response to receiving the input from the carrier indicating the shipment is complete via the user interface, the notifier is further configured to request a rating of the carrier from the shipper and a rating of the shipper from the carrier.

7. The system of claim 1, wherein:
wherein the user interface is further configured to receive shipment data for each shipment of a plurality of shipments from a shipper of a plurality of shippers.

8. The system of claim 1, wherein:
the user interface is further configured to receive shipment data for each shipment of a plurality of shipments from a shipper of a plurality of shippers; and
the database is configured to store the shipment data for each shipment of the plurality of shipments.

9. The system of claim 1, wherein:
the user interface is further configured to receive carrier data for each transport of a plurality of transports from a carrier of a plurality of carriers.

10. The system of claim 1, wherein:
the user interface is further configured to receive carrier data for each transport of a plurality of transports from a carrier of a plurality of carriers; and
the database is configured to store the carrier data for each transport of the plurality of transports.

11. The system of claim 1, wherein the shipment data comprises:
a weight,
a size,
a transport type,
an origination identifier,
a destination identifier,
an available date, and
a delivery date.

12. The system of claim 1, wherein the carrier data comprises:
a weight capacity available,
a volume available,
a transport type,
a transport route, wherein the transport route comprises a directed graph of global positioning system coordinates, and
a travel date.

13. The system of claim 1, wherein the carrier data comprises:
a weight capacity available,
a volume available,
a transport type,
a transport route, wherein the transport route comprises an origin identifier and a destination identifier, and
a travel date.

14. A method of maximizing freight capacity utilization, said method comprising:
receiving, via a user interface, shipment data from a shipper and carrier data from a carrier;
storing the received shipment data in a database;
matching, via a means for matching, shipment data stored in the database to the received carrier data;
displaying, via the user interface, matched shipment data to the carrier;
receiving from the carrier, via the user interface, a bid on a shipment corresponding the matched shipment data;
notifying, via a notifier, the shipper of the bid in response to receiving the bid on the shipment from the carrier, wherein the shipper corresponds to the shipment data in the bid received from the carrier;
receiving input from the shipper accepting the bid via the user interface; and
notifying, via the notifier, the carrier of the accepted bid in response to receiving, via the user interface, the input from the shipper accepting the bid.

15. The method of claim 14, wherein:
the user interface is further configured to receive shipment data for each shipment of a plurality of shipments from a shipper of a plurality of shippers;
the database is configured to store the shipment data for each shipment of the plurality of shipments; and
the means for matching matches the shipment data stored in the database to the received carrier data by:
filtering the database of stored shipment data to generate a filtered list of shipments, said filtering comprising:
excluding shipment data associated with shipments having a weight greater than a weight capacity available of the received carrier data;
excluding shipment data associated with shipments having a size greater than the volume available of the received carrier data;
excluding shipment data associated with shipments having a delivery date before a travel date of the received carrier data or an available date after the travel date of the received carrier data; and
excluding shipment data associated with shipments having a transport type incompatible with a transport type of the received carrier data;
determining a total distance for each shipment in the filtered list of shipments, wherein determining the total distance for a shipment comprises:
determining a first distance between an origin identifier of the shipment data of the shipment and an origin identifier of the received carrier data;
determining a second distance between a destination identifier of the shipment data of the shipment and the destination identifier of the received carrier data; and
adding the first distance with the second distance to determine the total distance for the shipment; and
ordering the filtered list as a function of the determined total distance for each shipment in the filtered list of shipments.

16. The method of claim 14, wherein:
the user interface is further configured to receive shipment data for each shipment of a plurality of shipments from a shipper of a plurality of shippers;
the database is configured to store the shipment data for each shipment of the plurality of shipments;
wherein the received carrier data comprises a transport route; and
the means for matching matches the shipment data stored in the database to the received carrier data by:
filtering the database of stored shipment data to generate a filtered list of shipments, said filtering comprising:
excluding shipment data associated with shipments having a weight greater than a weight capacity available of the received carrier data;
excluding shipment data associated with shipments having a size greater than the volume available of the received carrier data;
excluding shipment data associated with shipments having a delivery date before a travel date of the received carrier data or an available date after the travel date of the received carrier data; and
excluding shipment data associated with shipments having a transport type incompatible with a transport type of the received carrier data;
determining a total distance for each shipment in the filtered list of shipments, wherein determining the total distance for a shipment comprises:
determining a first distance between an origin identifier of the shipment data of the shipment and the transport route of the received carrier data;
determining a second distance between a destination identifier of the shipment data of the shipment and transport route of the received carrier data; and
adding the first distance with the second distance to determine the total distance for the shipment; and
ordering the filtered list as a function of the determined total distance for each shipment in the filtered list of shipments.

17. The method of claim 14, wherein:
the user interface is further configured to receive shipment data for each shipment of a plurality of shipments from a shipper of a plurality of shippers;
the database is configured to store the shipment data for each shipment of the plurality of shipments;
wherein the received carrier data comprises a transport route; and
the means for matching matches the shipment data stored in the database to the received carrier data by:
filtering the database of stored shipment data to generate a filtered list of shipments, said filtering comprising:
excluding shipment data associated with shipments having a weight greater than a weight capacity available of the received carrier data;
excluding shipment data associated with shipments having a size greater than the volume available of the received carrier data;
excluding shipment data associated with shipments having a delivery date before a travel date of the received carrier data or an available date after the travel date of the received carrier data; and
excluding shipment data associated with shipments having a transport type incompatible with a transport type of the received carrier data;
determining a total distance for each shipment in the filtered list of shipments, wherein determining the total distance for a shipment comprises:
determining a first distance between an origin identifier of the shipment data of the shipment and the transport route of the received carrier data;
determining a second distance between a destination identifier of the shipment data of the shipment and transport route of the received carrier data; and
adding the first distance with the second distance to determine the total distance for the shipment;
excluding, from the filtered list, shipments having a destination identifier closer to a beginning of the transport route than an origin identifier of the shipment; and
ordering the filtered list as a function of the determined total distance for each shipment in the filtered list of shipments.

18. The method of claim 14, wherein:
the database is further configure to store account information corresponding to the shipper; and
the input received from the shipper by the user interface accepting the bid is payment information; and
notifying the carrier of the accepted bid comprises providing stored account information corresponding to the shipper from the database to the carrier via the user interface.

19. The method of claim 14, further comprising:
receiving, via the user interface, input from the carrier indicating the shipment is complete; and
in response to receiving the input from the carrier indicating the shipment is complete via the user interface, requesting, via the notifier, a rating of the carrier from the shipper and a rating of the shipper from the carrier.

20. The system of claim 1, wherein:
the user interface is further configured to receive shipment data for each shipment of a plurality of shipments from a shipper of a plurality of shippers; and
the database is configured to store the shipment data for each shipment of the plurality of shipments.
